(19) United States
(12) Patent Application Publication
(10) Pub. No.: US 2011/0313882 A1
(43) Pub. Date: Dec. 22, 2011

(54) SYSTEM FOR CREATING AND PRICING AGGREGATED BUNDLES OF COMBINED GOODS AND SERVICES

(76) Inventor: Warren Barthes, Paris (FR)

(21) Appl. No.: 12/819,722

(22) Filed: Jun. 21, 2010

(51) Int. Cl. G06Q 30/00

(52) U.S. Cl. 705/26.25

(57) ABSTRACT

A computer implemented system and method for creating a bundle for purchase of multiple goods and services. A consumer is provided with choices for multiple products and services. The services may be related to one or more of the products being offered. As the consumer progresses through goods and services being offered, prices are calculated instantaneously from the consumer's point of view and other goods and services for bundling with previous choices are offered. Particular calculating methods are used to optimize the pricing for the bundled goods and services. Pre-set bundles may also be offered. Pre-set bundles may also be offered where certain components can be interchanged for other goods and services in a manner which may or may not affect the price.

### BACKGROUND

This invention relates to the field of electronic commerce.

Traditionally, electronic commerce over the internet is conducted on an item-by-item basis. Multiple schemes exist for conducting such item-by-item commerce, such as the “shopping cart” model, where a purchaser browses through a catalog of items and selects items he or she wishes to purchases one-by-one. As items are selected they are added to a virtual shopping cart. When the user has completed his or her shopping they proceed to a virtual checkout whereby they typically have the options to adjust the items in the cart, provide the seller with additional details (such as shipping information, payment information, etc.), provide coupon details, and approve the purchase transaction.

Another known commerce model is the “one-click” model where certain information about a consumer is gathered in advance (such as shipping information, payment information, etc.) and when a consumer wishes to purchase an item, he or she simply clicks an appropriate button and the purchase transaction for that item is automatically initiated.

These models work best with stand-alone goods that are not sold with other goods or services.

### SUMMARY OF THE INVENTION

What is offered is a system and computer implemented method for optimizing bundled sales of at least one product and at least one service, the system comprising a computer readable medium with computer executable instructions for, and the computer implemented method comprising executing, on at least one computer, computer executable instructions for, receiving data representing a cost of at least two products and at least one service, receiving data representing a first consumer selection of either a service or a first product, determining, at least in part based on the data representing the first consumer selection, a choice of either a service or a second product, receiving data representing a second consumer selection of either a service or a second product; and determining, at least in part based on the first consumer selection and the second consumer selection, a purchase bundle to be offered to the consumer; wherein the purchase bundle includes at least three components, the at least three components comprising at least two products and at least one service, wherein at least two of the three components are chosen by the consumer, and wherein the service is related to at least one of the at least two products.

Further, after receiving data representing the first consumer selection, the system and method may calculate at least one price option for the first consumer selection, wherein the price option depends on the second consumer selection. The system and method may also present the price option to a consumer prior to the consumer making the second consumer selection. The system and method may also, after receiving data representing the second consumer selection, determine, at least in part based on the data representing the second consumer selection, a further choice for the consumer of either a service or a second product; and receive data representing a third consumer selection of a service or a second product. The system and method may also, after receiving data representing the second consumer selection, calculate at least one price option for the purchase bundle, wherein the price option depends on the third consumer selection. At least one of the at least two products may be a mobile electronic device and the at least one service may be related to the mobile electronic device.

### BRIEF DESCRIPTION OF THE DRAWINGS

FIG. 1 is a block diagram of user interfaces, a program server, and data storage according to one embodiment;

FIG. 2 is a block diagram of a general purpose computer according to one embodiment;

FIG. 3 is a flowchart of a method according to one embodiment;

FIG. 4 is a flowchart of a method according to one embodiment;

FIG. 5 is a block diagram of a retailer computer, a service provider computer, a product provider computer and a program server according to one embodiment.

### DESCRIPTION

Presented is a method and system for aggregating bundles of combined goods and services for offer of purchase to consumers. As used herein a “bundle” or “purchase bundle” means a combination of goods and/or services which is offered to a consumer for purchase. The method and system are directed to allowing goods and services to be combined in a manner which may encourage potential consumers to purchase certain goods and services by enabling consumers to customize purchased bundles from among various choices, and be presented with advantageous pricing options, in a rapid and efficient manner. The method and system presented allow the creation of such bundles, and the calculation of the price of such bundles and potential consumer savings over alternative methods of purchasing, in a way that benefits both consumers and sellers and providers of such goods and services. The method and system presented may also provide consumers with instant “rewards” whereby consumers are provided with additional benefits, products, or lower prices, at the outset of a purchasing decision rather than after reaching particular milestones such as a certain period of service subscription, purchasing minimums, etc.

In one embodiment the method and system is used to offer consumers a cellular telephone and associated service plan. In addition, the consumer is offered a typically unrelated good, such as a piece of electronics (e.g., video game console, television, etc.) as an incentive for choosing a particular cell phone or plan. Or the consumer may be offered a particular cellular telephone or service plan as a way of acquiring the piece of electronics for free, or at a discounted or bundled price. By aggregating goods and services in the manner provided, consumers may be offered lower initial prices, higher quality goods, or other benefits, as a result of aggregating the goods for purchase. Further, the method and system provided allow for rapid calculation and adjustment of prices and other purchased terms to a consumer that had previously been available. Preferably such calculations are performed in or close to real time with a minimum of wait time from the consumer perspective.

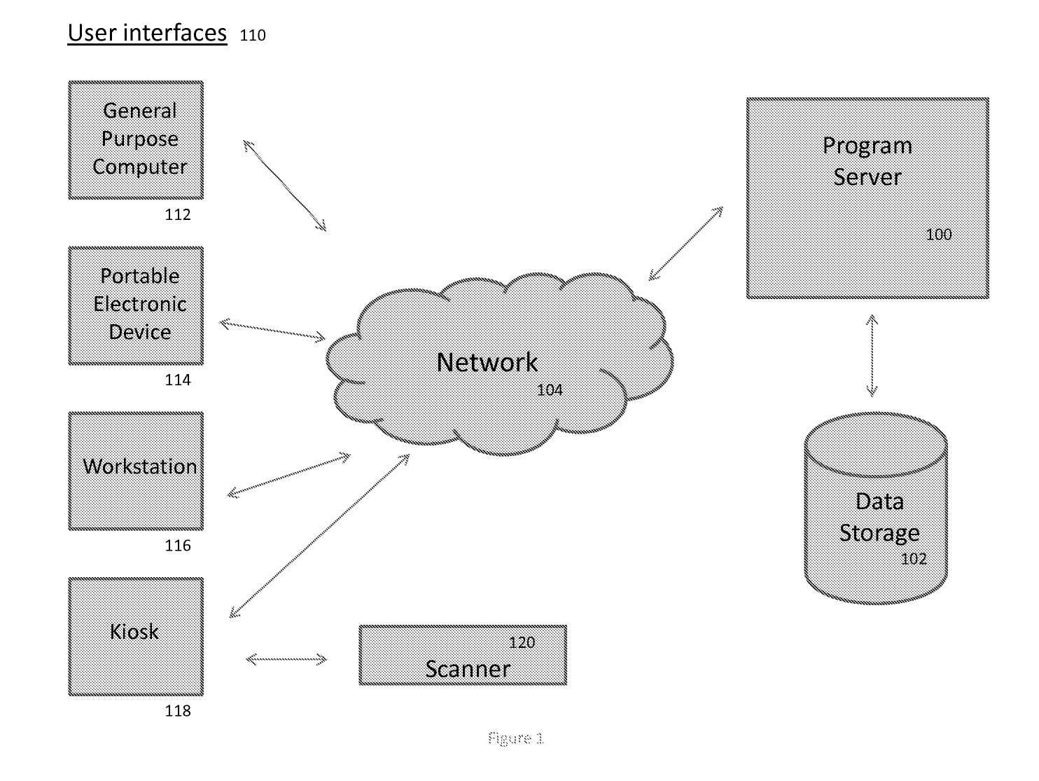

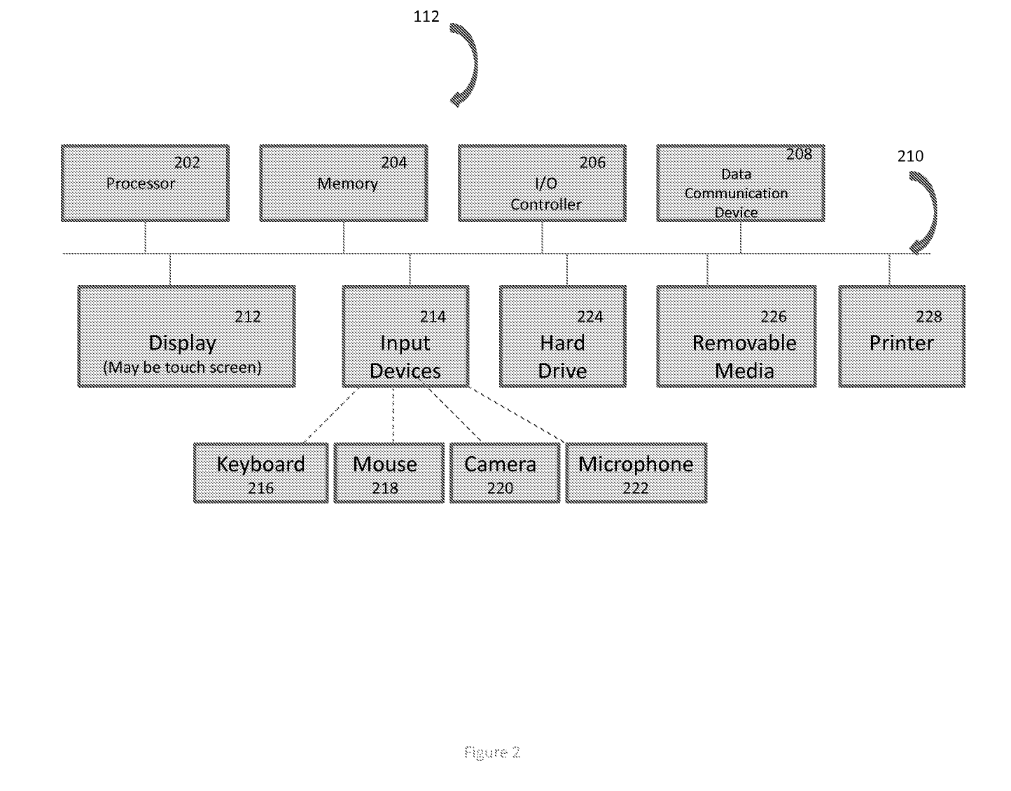

The system for creating purchase bundles may be structured in a variety of ways. One embodiment of such a system is shown in FIG. 1. As shown in FIG. 1, one embodiment of the system includes one or more user interfaces 110 (for example, a general purpose computer 112 or portable communication device 114) connected to a network 104. Computer programs which comprise computer readable media which store executable instructions to implement embodiments of the invention are stored on a program server 100, which may be another computer, that can be implemented as the type disclosed as general purpose computer shown in FIG. 2. Generally a server has high performance components, such as a high speed processor and storage device (e.g. hard drive), and a large amount of memory. Although the term server is used with regard to program server 100, any computer executed implementation may be used to perform the method and system; a server/client implementation is not necessarily required. The programs are stored on the server 100 and may be executed in a computer program language such as HTML, AJAX, JAVA, etc. They may also be developed in Flash or with the help of dynamic programming languages such as PHP, JSP (Java Server Pages), ASP (Active Server Pages), .net, etc. The user interface 110 may interact with the system through dedicated software or through software, such as Explorer, Safari, Firefox, or Chrome. The interaction software downloads the programs from the program server 100, and executes the programs. The programs communicate with the program server 100. The use of a network 104 and browser software makes the programs available to large number of computers on the network simultaneously. This facilitates operation of the system by multiple users at the same time.

In one embodiment, the method and system is accomplished through the operation of one or more computers programmed to assist in the execution of the method. A block diagram of an example of such a computer is shown in FIG. 2. The computer can be any computer 112 or workstation 116 such as a server or a personal computer running Microsoft Windows, Apple's operating system, or UNIX, etc. The computer may also be a portable electronic device capable of interacting with the system. The particular type of computer or workstation is not central to the invention. In fact, the invention can be implemented in a variety of ways including an all-hardware embodiment in which dedicated electronic circuits are designed to perform all of the functionality that the programmed computer can perform. One embodiment of the invention is an implementation in software which operates among a web server (such as the program server 100), a storage device 102 or computer which hosts data related to various products and services, and one or more user computers or communication devices 110 which are connected to the internet. In other embodiments users connect to the system through the use of portable electronic communication devices 114, dedicated terminals, kiosks 118, or other communication portal.

Referring to FIG. 2, the general purpose computer 112 typically will include a central processor 202, a main memory unit 204 for storing programs and/or data, an input/output (I/O) controller 206, a display device 212 (which may be capable of touch screen operation), and a data bus 210 coupling these components to allow communication there between. Alternatively, the general purpose computer can be structured so that a central data bus is not used, but rather the various components communicate via other data paths. The memory 204 generally includes random access memory (RAM) and read only memory (ROM) chips. The computer 112 typically also has one or more input devices 214 such as a keyboard 216, a mouse 218, a camera 220, a microphone 222, and/or a touch screen display 212. The computer may also have a hard drive 224 with hard disks therein and the ability to accept data from removable media 226 such as a DVD/CD, flash drive, memory card, etc. The computer typically has a data communications interface 208 to allow communication with other computers on a network (either the internet or a different network), such as a modem, an Ethernet or wireless networking connection, Bluetooth interface, etc. Other devices also can be part of the computer including output devices (e.g., printer 228). In one embodiment, one or more computer programs define the operational capabilities of the computer 112. These software programs can be stored in the hard drive 224 and/or into the memory 204 of the computer via a removable media connection 226 or the data communications interface 208.

Referring again to FIG. 1, a user may connect using a portable electronic communication device 114. Such devices typically are smaller versions of the general purpose computer and typically have a central process, a memory unit, a display device (which may be capable of touch screen operation), and a data bus coupling these components to allow communication there between. The device may also have a camera, microphone, and/or the ability to connect to other peripheral devices (through Bluetooth or other means) for input/output purposes such as a keyboard, headset, external display, printer, etc. The device 114 typically has a data communication interface which allows wireless connection to a telephone network and/or the internet.

In addition, the user interface 110, may be located at a store, kiosk, or be otherwise accessible from a public location. That public location may even be a location where the goods/services being bundled are sold. An advantage to such placement of the user interface 110 is that the goods may be available for a user to inspect before inquiring about purchase and sales agents or other personnel may be available to answer questions about the goods, services, or bundling procedure/options. Such placement may also allow the use of scanning technology, such as a barcode scanner 120, to input a user choice of one or more products or services. Although not shown in FIG. 1, such scanning technology may also be employed with other user interfaces 110 besides the kiosk.

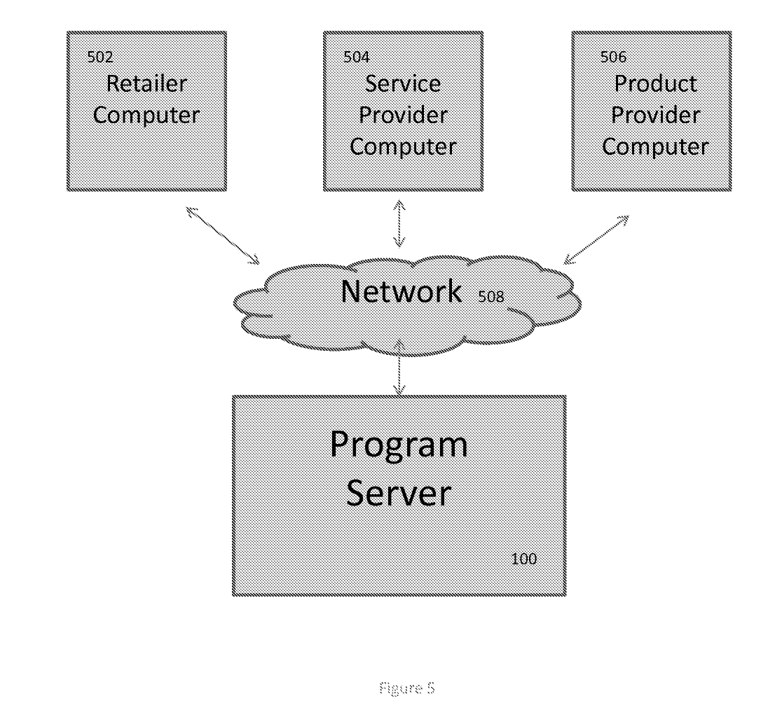

As shown in FIG. 1, the method and system may make use of one or more units of data storage 102 which contain information related to goods and services being offered to consumers. Such information may include the cost of goods being offered, typical profit made on such goods, pricing of goods in other purchasing contexts, the cost of services offered, pricing of services in other purchasing contexts, typical periodic fees for such services, profits for such services, commissions to be paid on sales of goods and services, user information (including biographical information, purchase history, service history, etc.), sales tax information, information related to various service providers, or various other categories of data. Although only a single data store is shown in FIG. 1, multiple data stores 102 may be used to provide the data necessary to create purchase bundles and their associated pricing. Further, the data storage 102 may be located with a computer which creates purchase bundles, such as the program server 100, or may be located separately such as with a retailer computer, service provider computer, or product provider computer, as shown in FIG. 5. The data storage 102 may also be directly connected to the program server 100 or may communicate with the program server 100 through a network 104 or 508.

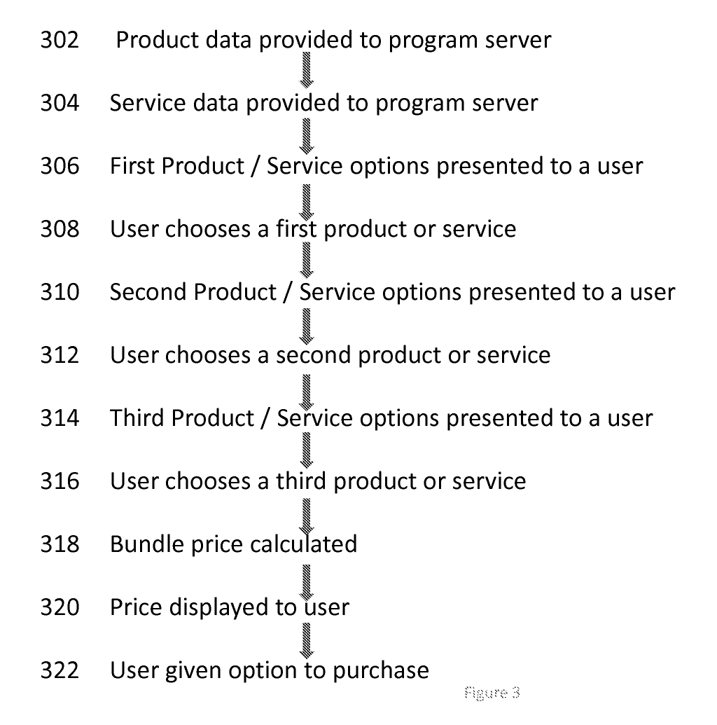

FIG. 3 shows a sample process flow of the provided method. Although shown in one exemplary order, the steps may be performed in a different order than shown in FIG. 3. Product data and service data are provided to a program server 302 and 304. Although not shown, additional data may be provided to the program server for performing the aggregating/pricing method. The program server may perform operations on the data received in order to prepare the product and service offerings for presentation to the potential consumer. Once the program server has performed any data operations or initialization, a first product or service option is presented to a user 306. The presentation to a user may occur in a variety of methods, but the preferred method for doing so is utilizing an internet webpage which may display a variety of purchasing options to the user. Unless otherwise noted, the terms “user” and “consumer” are used interchangeably in this description.

The user may be initially presented with a single product or service, multiple products or services, or predetermined bundles of products and services. The user may also be presented with various pricing options for a product or service, including pricing options that may depend upon later choices of additional products or services. The user may also be presented with comparative pricing options for the first product or service in other consuming environments (such as those offered by a competitor) or those which do not depend on later purchases. For example, a user may be presented with one price option for a piece of electronics that may be found in a typical retail environment and another price option for the piece of electronics when it is bundled with another product (such as a cell phone) and a service plan (such as a cell phone subscription). The data used to present this information to the user is typically found in the data storage 102 and passed through the program server 100, but it may come from other sources as well. The user may also be presented with overall pricing or terms for a bundle of goods and services. This overall pricing may include a comparison of bundled prices versus costs of purchasing the items separately.

A user then chooses a first product or service 308 and that choice may be communicated to the program server (not shown). In certain cases this first choice may be a service, but in the typical case this first choice is a good. In one embodiment the first choice is an item of electronics unrelated to a service plan. In another embodiment the first choice is a cell phone that is related to a service plan to be included in a product bundle. The system then may perform operations to determine what additional products or services may be offered to a user or the system may have already determined those choices depending on operations earlier performed. Additionally, calculations may be performed to display to the user updated pricing information that depends on the first product/service chosen. Choices for other goods/services may also be presented to the user at this point. The second product/service options may then be presented to a user 310. The user then chooses a second product or service 312. Additional calculations are then performed as necessary to determine a third product/service option to be presented to a user, updated pricing information, etc. In one embodiment, if no service has yet been chosen by the user at this point, the third option will typically be a service related to one of the goods previously chosen (for example, a cell phone plan related to a previously chosen cell phone).

A third product or service option may then be presented to a user 314. The user may then choose a third product or service 316. Once the user has chosen at least one service option and two product options at least one bundle price is calculated at 318 and displayed to a user 320. Also included may be pricing or terms related to the service included in the bundle. The user is then given the option to purchase the bundle 322.

In one embodiment, one or more of the goods or services included in the bundle above may be assigned by the system rather than chosen by the user. An example of such a situation is a particular cell phone may only be available with one service plan so that service plan will be included in the bundle rather than giving the user a choice of service. Other instances of good/service selection may also occur which remove one or more choices made by the user in the process described above.

In another embodiment a user may be presented with a preset bundle for purchase. The user may opt to purchase the bundle as presented (using a shopping cart model, a “one-click” model, or some other purchasing technique) or may be presented with the option to select one or more items in the bundle for potential purchase or recombination with other bundle items or pricing options. The user may also be given the option to substitute one or more components of the bundle for other goods or services. The choices for other goods or services may be pre-selected so as to not disturb the price of the bundle. They may also be pre-selected to alter the price in specific ways, and those ways may be displayed to the consumer. For example, the consumer may be offered a preset bundle but may also be shown specific alternate choices for a product or service that increase the price (e.g. “For $50 more you can get item A instead of item B”), decrease the price (e.g. “To save $50 choose item B instead of item C”) or maintain the price (e.g. “Swap service A for service B at no extra charge”). This displaying of alterable components for preset bundles may be done for one good or service or multiple goods or services.

In one embodiment the bundling system is used for presenting to the consumer a bundle comprising one cell phone or mobile electronic device, a service plan related to the operation of the cell phone or mobile electronic device, and a gift or electronic item typically unrelated to the service plan. A user may encounter an offered bundle, typically on an internet website. Individual products or service plans may be presented to a user separately or preset bundles may be presented to a user. The user may then select one or more products or bundles to investigate further and potentially customize with goods and services, typically of the users choosing.

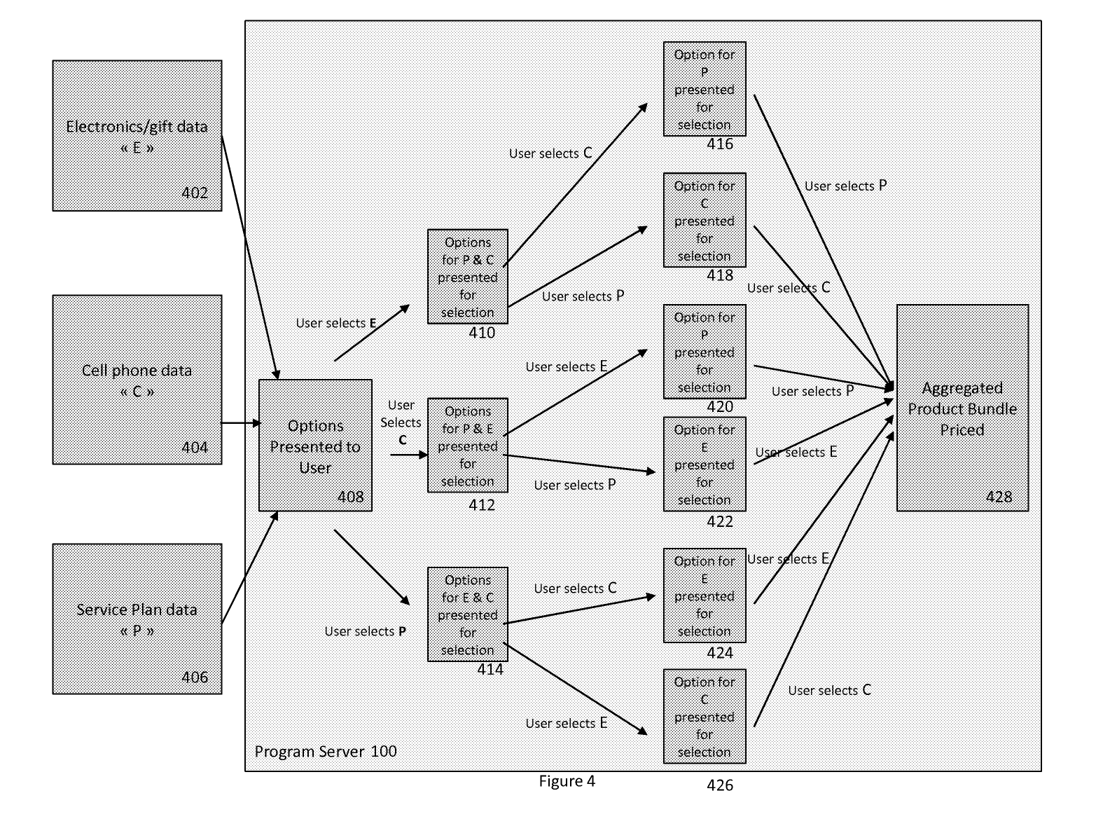

FIG. 4 shows one embodiment of a user selecting a bundle comprising a cell phone C, a service plan P, and an item of electronics E. Although FIG. 4 shows a number of steps being performed by the program server 100, these steps may be performed on other physical machines, including by a device executing computer readable instructions which may be located in different physical locations such as a user's general purpose computer, a user's portable electronic device, or a work station or kiosk as portrayed in FIG. 1. Referring again to FIG. 4, data regarding available electronics and other products, such as gifts 402, cell phones 404 and service plans 406 are made available to the executing program server 100. For purposes of illustration the operation is shown as being executed by the program server 100, though various steps may be executed by other physical machines. Although not shown, in one embodiment it may be desirable for the system to obtain certain user information (such as name, location of residence, credit card number, credit rating, etc.) prior to creating a bundle.

The program server 100 receives the data related to the electronics, cell phone, and service plan. The program server 100 may perform various operations on that data to prepare the program server for offering to a user bundles and sales terms (including pricing) related thereto. The options for purchases (whether shown in pre-aggregated bundles or as individual products) are presented to a user 408. The user is then given the option to purchase the entire bundle or to customize the bundle according to the consumer's individual preferences. If the user desires to customize the bundle he or she may select a particular good or service plan as a first choice and then be presented with additional goods or services with which to complete the bundle. The items to the right of 408 demonstrate the options that may be presented to the user for selecting one item each from categories E, C, and P and the order in which those choices are made prior to the user being presented with an aggregated bundle and associated pricing/terms 428.

By way of example, if a user selects an electronics item E from the initial choices, the user is then presented with additional options for cell phone C or cell phone service plan P 410. The user may then select a particular cell phone C at which point options for a service plan P are presented to the user 416. Once the user selects the service plan P the aggregate bundle is compiled by the program server and various pricing options may be presented to the user 428. If, when the user is presented with options for a cell phone C and service plan P 410 the user selects the service plan P, the user will then be presented for an option for a cell phone 4C 18 following which the user will be shown an aggregated bundle according to his or her individual choices 428. In the embodiment shown in FIG. 4, the user may select the electronics E, cell phone C, and cell phone plan P, in any order desired by the user. In certain embodiments a particular order of choices may be determined for the user. The user is typically presented with new options for unselected goods or services until such time as the bundle is complete and the aggregated bundle price options are calculated and presented to a user 428.

At various stages in the process of selecting goods or services to be aggregated into the bundle the system may calculate new pricing models or purchase terms for selected or potentially selectable goods or services. At various stages the system may also determine what further goods or services may be offered to the user to either individually or as part of a bundle. At various stages the system may also take in or consider other information regarding the user, the offered goods and services, or other data that may be relevant to the offering or purchase of a bundle. Examples of such information include inventory quantities, potential shipping dates, service contract commitments, previous user purchases, user credit ratings, forthcoming new products or services, product reviews, purchase incentives, etc. This information may be presented to the user or may be incorporated into the calculations to determine what goods and services to offer to the user and what pricing/conditions apply to each good, service, or bundle.

The system preferably incorporates information changes, such as new information as described above, user choices, etc. in a rapid manner as close to real time as possible, with minimal delay or interruption to a user. For example, a user may preferably be able to toggle between various product or service choices and be displayed other potential goods and services which may be incorporated into bundle, purchase terms or conditions (including price), or other information rapidly along with each choice considered by the user.

An example method for calculating the price of a purchase bundle is provided below using the example of a bundle of one cell phone, one cell phone service plan, and one electronics item.

x=(((y+z)+(μ+ω))−f)p

where
x is the price of the bundle;
y is the net cost of the electronic device;
z is the net cost cell phone;
f is the commission on the service plan;
μ is the margin on the electronics item;
ω is the margin on the cell phone plus service plan; and
p is any applicable sales tax.

Other methods of calculating the price may be used, but the above is one preferred method. In certain situations a price for a cell phone or plan may be imposed by a carrier. In that situation a method for calculating the price of the bundle that may be used is:

x=((y+w)−(R−U)+M)p

where
x is the price of the bundle;
y is the price of cell phone and service plan (in this example, imposed by the carrier);
w is the price of electronic device;
R is the commission on sale of the cell phone and service plan;
U is the cost of the cell phone; and
p is the applicable sales taxes.

Other methods of calculating the bundle price may be used. It is preferred that the information used to calculate the bundle price be accessible by the system so that calculation, display, and any necessary recalculations be performed as quickly as possible (preferably with no observable delay) from the perspective of the user.

Once the user has selected a bundle the user's choices may be stored by the system. A number of methods may be used to prepare the bundle for purchase. The system may incorporate a shopping cart model, a one-click model, or other form of commerce management. Users may be permitted to purchase the bundle by providing financial information (such as banking information, credit card number, etc.), by using a gift card, or simply by opting to select the bundle, their authorization to purchase being confirmed by the system in a previous step. Following selection of the bundle the user may be presented with other options regarding the bundle such as selecting a different model for a previously selected good, a different service plan, various pricing/purchase terms (including up front cost, monthly/periodic plan service fee, cell phone carrier, desired data plan, additional lines, etc.). The system can collect this information to update the user's bundle purchase and, if necessary, to ensure the user is provided with the desired goods and services from their respective providers.

As shown in FIG. 5, the program server 100 may communicate with computers from other entities, for example retailers 502, service providers 504, or product providers 506. These communications may take place over a network 508 (which may be the same as or a different network from network 104 shown in FIG. 1). These communications may also take place with direct connections. Further, the system may operate as part of one of these other entities' computers. Communications between the system and the other entities may happen at any stage in the preparation and sale of bundles. Including when initially providing the system with data regarding the use, the goods and services, etc. and following completion of the user indicating he or she wishes to purchase a specific bundle. The system may also communication with these other entities as part of the purchasing process to confirm the user's purchase of the bundle and to manage any information (including shipping address, service initialization information, selected data plan, etc.) that must be exchanged to ensure the user is provided with the goods and services desired.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A system for optimizing bundled sales of at least one product and at least one service, the system comprising a computer readable medium with computer executable instructions for:
receiving data representing a cost of at least two products and at least one service;
receiving data representing a first consumer selection of either a service or a first product;
determining, at least in part based on the data representing the first consumer selection, a choice of either a service or a second product;
receiving data representing a second consumer selection of either a service or a second product; and
determining, at least in part based on the first consumer selection and the second consumer selection, a purchase bundle to be offered to the consumer; wherein:
the purchase bundle includes at least three components, the at least three components comprising at least two products and at least one service, wherein at least two of the three components are chosen by the consumer, and wherein the service is related to at least one of the at least two products.

2. The system of claim 1 further comprising computer executable instructions for, after receiving data representing the first consumer selection, calculating at least one price option for the first consumer selection, wherein the price option depends on the second consumer selection.

3. The system of claim 2 wherein the price option is presented to the consumer prior to the consumer making the second consumer selection.

4. The system of claim 1 further comprising computer executable instructions for:
after receiving data representing the second consumer selection, determining, at least in part based on the data representing the second consumer selection, a further choice for the consumer of either a service or a second product; and
receiving data representing a third consumer selection of a service or a second product.

5. The system of claim 4 further comprising computer executable instructions for, after receiving data representing the second consumer selection, calculating at least one price option for the purchase bundle, wherein the price option depends on the third consumer selection.

6. The system of any of claims 1-5 wherein at least one of the at least two products is a mobile electronic device and the at least one service is related to the mobile electronic device.

7. A computer implemented method for optimizing bundled sales of at least one product and at least one service, the method comprising executing, on at least one computer, computer executable instructions for:
receiving data representing a cost of at least two products and at least one service;
receiving data representing a first consumer selection of either a service or a first product;
determining, at least in part based on the data representing the first consumer selection, a choice of either a service or a second product;
receiving data representing a second consumer selection of either a service or a second product; and
determining, at least in part based on the first consumer selection and the second consumer selection, a purchase bundle to be offered to the consumer; wherein:
the purchase bundle includes at least three components, the at least three components comprising at least two products and at least one service, wherein at least two of the three components are chosen by the consumer, and wherein the service is related to at least one of the at least two products.

8. The computer implemented method of claim 7 further comprising, after receiving data representing the first consumer selection, calculating at least one price option for the first consumer selection, wherein the price option depends on the second consumer selection.

9. The computer implemented method of claim 8 wherein the price option is presented to the consumer prior to the consumer making the second consumer selection.

10. The computer implemented method of claim 7 further comprising:
after receiving data representing the second consumer selection, determining, at least in part based on the data representing the second consumer selection, a further choice for the consumer of either a service or a second product; and
receiving data representing a third consumer selection of a service or a second product.

11. The computer implemented method of claim 10 further comprising, after receiving data representing the second consumer selection, calculating at least one price option for the purchase bundle, wherein the price option depends on the third consumer selection.

12. The computer implemented method of any of claims 7-11 wherein at least one of the at least two products is a mobile electronic device and the at least one service is related to the mobile electronic device.
